(19) United States
(12) Patent Application Publication
(10) Pub. No.: US 2003/0186744 A1
(43) Pub. Date: Oct. 2, 2003

(54) Multi-tiered tournament

(76) Inventor: Jed Bradell, Kansas City, MO (US)

Correspondence Address: THOMAS B. LUEBBERING, HOVEY WILLIAMS LLP, Suite 400, 2405 Grand, Kansas City, MO, 64108, US

(21) Appl. No.: 10/108,125

(22) Filed: Mar. 26, 2002

(51) Int. Cl. G06F 19/00; G06F 17/00

(52) U.S. Cl. 463/42

(57) ABSTRACT

A tournament method (10) is conducted in two phases, in which a plurality of competitors (22) compete for a prize. A first phase comprises conducting a plurality of lower-tier tournaments (28), while a second phase comprises conducting a upper-tier tournament (30). Each lower-tier tournament (28) is kept small by limiting how many competitors (22) may be assigned according to a threshold number. The upper-tier tournament (30) is kept small, since only lower-tier winners are allowed to compete, therein. The prize is significantly larger than the threshold number multiplied by an entry fee paid by each competitor (22). The threshold number ensures that the prize is worth more than the sum of the entry fees for any one lower-tier tournament 28. In this manner, the threshold number allows the entry fee to be minimized and the prize to be maximized, while keeping each tournament (28,30) small, manageable, and enjoyable.

### BACKGROUND OF THE INVENTION

1. Field of the Invention

The present invention relates to tournaments in which competitors compete for a prize. More particularly, the present invention provides a multi-tiered tournament method that allows a plurality of competitors to pay a small entry fee to compete in limited numbers in one of a plurality of lower-tier tournaments for a chance to compete for a large prize in an upper-tier tournament.

2. Description of Prior Art

Many people enjoy competing in tournaments for various sport and gaming activities including pool, card games, board games, and computer games. Competitors typically prefer competing in smaller rather than larger tournaments. Small tournaments are easy to manage and can be conducted in relatively short time periods and therefore, do not require large investments of time. Additionally, small tournaments can be social functions allowing competitors to get to know each other.

However, competitors also enjoy competing for large prizes. Large prizes require either a large tournament or a large entry fee. While large tournaments are able to pool many small entry fees to create a large prize, large tournaments are difficult to manage and require large investments of time. Therefore, large tournaments are less enjoyable for competitors than small tournaments. Additionally, competitors do not enjoy paying large entry fees.

Currently there is no method that allows a competitor to pay a small entry fee to compete in a small tournament for a large prize. Accordingly, there is a need for an improved multi-tiered tournament structure that overcomes the limitations of the prior art.

### SUMMARY OF THE INVENTION

The present invention overcomes the above-identified problems and provides a distinct advance in the art. More particularly, the present invention provides a multi-tiered tournament method that allows a plurality of competitors to pay a small entry fee to compete in limited numbers in one of a plurality of lower-tier tournaments for a chance to compete for a large prize in an upper-tier tournament.

The tournament method of the present invention is preferably conducted in at least two phases, each phase comprising several small steps. A first phase broadly comprises conducting the plurality of lower-tier tournaments, while a second phase broadly comprises conducting the upper-tier tournament. Each lower-tier tournament is kept small by limiting how many competitors may be assigned according to a threshold number. Additionally, the upper-tier tournament is kept small, since only competitors who win one of the lower-tier tournaments are allowed to compete in the upper-tier tournament.

For computer gaming tournaments, each competitor must acquire a game software package and a personal computer with access to a network allowing them to run the game software package and connect to a game server. Each competitor is also expected to use the game software package to connect to the game server prior to entering any tournaments in order to become familiar with the game software package's operation, as well as, learn skills necessary to compete and build a character.

Each competitor must also acquire a network address from a web server. The game software package must be configured with the network address in order to connect to the game server. In addition to the network address, the web server is used to post other information about the tournament method, such as, schedules and rules.

Each competitor must further register their character with and pay the entry fee to a billing server. When the competitors register, they are allowed to choose which one of the plurality of lower-tier tournaments in which they would like compete. Each lower-tier tournament starts on a different date and/or at a different time.

A game master collects registration information from the billing server and creates a tournament plan according to a threshold number which limits how many competitors may be assigned to each lower-tier tournament. The tournament plan specifies how the lower-tier tournaments will be conducted and which competitors are assigned to each lower tier-tournament. Each competitor is preferably assigned to the lower-tier tournament they chose, but may be assigned to another lower-tier tournament for any number of reasons, such as, too many or too few competitors have chosen a particular lower-tier tournament. The game master conducts each tournament on the game server according to the tournament plan.

Competitors who win one of the lower-tier tournaments are referred to as lower-tier winners and allowed to compete in the upper-tier tournament. Competitors who win the upper-tier tournament are referred to as upper-tier winners and awarded the prize.

The prize is significantly larger than the number of competitors in any one tournament multiplied by the entry fee. The prize may draw upon entry fees from each lower-tier tournament and may be much larger than conventionally possible. The threshold-number allows the entry fee to be minimized and the prize to be maximized, while keeping each tournament small and manageable. This increases each competitor's enjoyment of and potential profit from the tournament method.

In use, each competitor acquires the game software and the network address of the game server. Each competitor creates and builds their character on the game server. The competitors also register with the billing server and pay the entry fee. Then, shortly before the lower-tier tournament to which they are assigned is scheduled to start, each competitor configures the game software with the network address of the game server and connects to the game server. Then, the competitors wait for the game master to start the assigned lower-tier tournament. The competitors use their character to compete in the assigned lower-tier tournament. Once each lower-tire tournament is complete, the lower-tier winner or winners are announced and allowed to compete in the upper-tier tournament for the prize.

Shortly before the upper-tier tournament is scheduled to start, all lower-tier winners connect to the game server. The lower-tier winners wait for the game master to start the upper-tier tournament. The lower-tier winners use their character to compete in the upper-tier tournament. Once the upper-tier tournament is complete, the upper-tier winner or winners are announced and awarded the prize.

### BRIEF DESCRIPTION OF THE DRAWINGS

A preferred embodiment of the present invention is described in detail below with reference to the attached drawing figures, wherein:

FIG. 1 is a block diagram of a computer system operable to support a multi-tiered tournament method according to the present invention;

FIG. 2 is a block diagram of two phases of the multi-tiered tournament method of the present invention;

FIG. 3 is a block diagram of three phases of the multi-tiered tournament method of the present invention;

FIG. 4 is a flow chart showing a method of participating in a lower-tier tournament of the multi-tiered tournament method according to the present invention; and

FIG. 5 is a flow chart showing a method of participating in an upper-tier tournament of the multi-tiered tournament method according to the present invention.

### DETAILED DESCRIPTION OF A PREFERRED EMBODIMENT

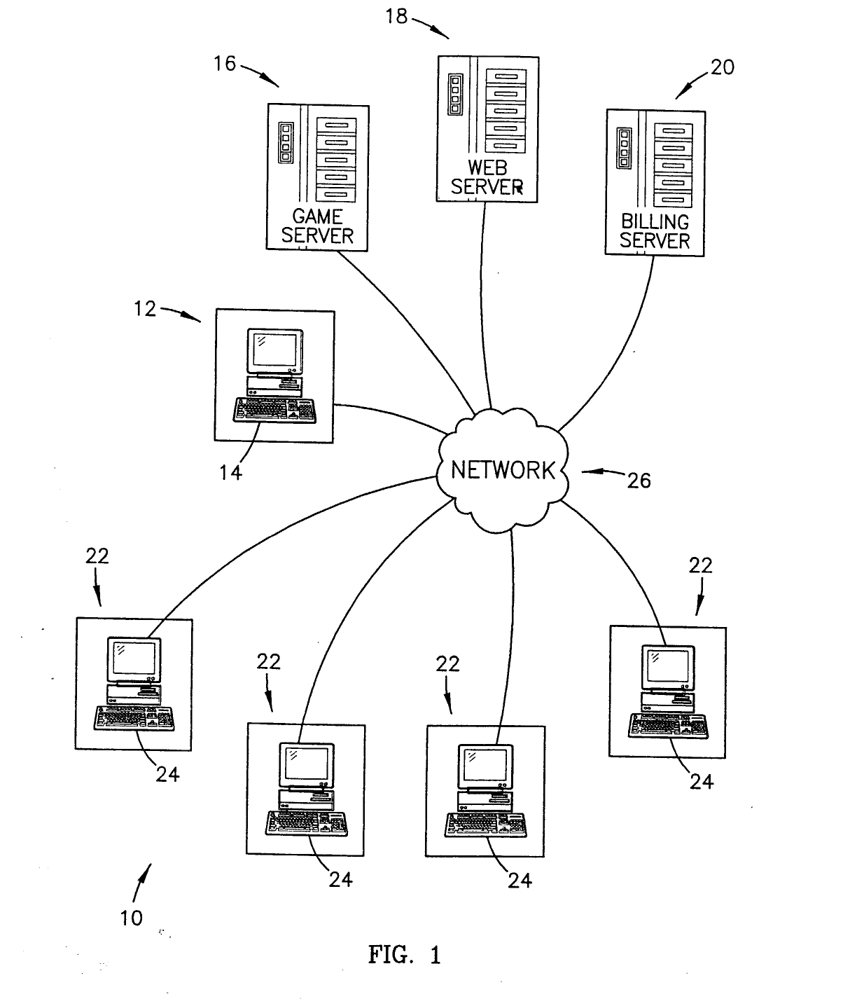

FIG. 1 illustrates certain computer equipment which may be used to implement a preferred embodiment of the tournament method 10. The preferred tournament method 10 is conducted by a game master 12 operating a game master computer 14. The game master 12 uses the game master computer 14 to connect with a game server 16 for hosting the tournament method 10, a web server 18 for posting information relating to the tournament method 10, and a billing server 20 for receiving registration data relating a plurality of competitors 22. Each competitor 22 operates a personal computer 24 to connect with each of the servers 16,18,20. The servers 16,18,20 and computers 14,24 are preferably connected to each other through a network 26.

The game master 12 is preferably a representative of an internet gaming company or club. The company preferably facilitates the tournament method 10 as a business. There may be a company network connecting the game master computer 14 and/or any of the servers 16,18,20 together in a secured manner. The company network may allow the game master 12 or any other representative of the company open access to each server 16,18,20, while restricting outside access to the servers 16,18,20.

Similarly, there may be a firewall element between any of the servers 16,18,20 and the competitors 22. The firewall element may be implemented by additional servers, by secured routers, or any combination of commonly used network security techniques.

The game server 16 is connected to the network 26 and is used to host the tournament method 10. More than one game server 16 may be used in order to facilitate the tournament method 10. For instance, two or more game servers 16 may be used in conjunction with each other in order to divide the workload between them. This may allow more competitors 22 to compete simultaneously. Additionally, two or more game servers 16 may be used separately in order to host two or more tournaments simultaneously. The game server 16 is preferably administered by the game master 12 or another representative of the company.

The game server 16 runs a game server software that is operable to aid in construction of a gaming environment and host a plurality of characters who exist only in the gaming environment. Each character is preferably created and controlled in the game environment by one of the competitors 22. The server software is preferably of the type available from Past Tree, Inc.

Past Tree, Inc. provides a Massively Multi-player Online Role Playing Game (MMORPG) Construction Kit that is sold as a game software package and includes both the server software and a client software which is used by each competitor 22 on one of the personal computers 24. The server software allows the game master 12 to create the gaming environment to mimic a real world region or a fantasy world. Additionally, the gaming environment may be created to mimic any time frame from the past, present, or future. The preferred gaming environment combines a dark age fantasy world with imaginary races, such as, elves and dark age character classes, such as, fighters, thieves, and wizards. Each competitor 22 creates a character of their choosing with one of the races and according to one of the classes. For example, a particular competitor 22 may create a particular character that is an elf and a wizard.

Each competitor 22 is expected to acquire the game software package and install at least the client software on his or her personal computer 24. Each competitor 22 must also connect to the game server 16 through the network 26 to create their character. Each competitor 22 gives their character a character name and controls their character in the gaming environment. While each competitor 22 controls their character in the gaming environment, their character gains experience and advances in skills and levels.

For example, each character begins as a level one character. Each level one character has very basic skills, as appropriate for their class, and minimal experience. When the level one character defeats one of a plurality of monsters in the gaming environment, that character gains experience and may advance to become a level two character. This advancement may bring additional skills, which may help the level two character defeat more monsters and become a level three character. This process is repeated, building on experience and skills along the way. Additionally, each character becomes stronger and healthier, making them a more powerful opponent.

The web server 18 is used to post information relating to the tournament method 10. The web server 18 may be used to post information relating to how each competitor 22 can connect to the game server 16, such as, a network address and/or a port number. The web server 18 may also contain such information as tournament schedules, tournament types, tournament results, tournament rules, numbers of lower-tier winners, numbers of upper-tier winners, and prize sharing rules. The web server 18 is preferably administered by the game master 12 or another representative of the company.

The billing server 20 is used to collect an entry fee from each competitor 22 and register each character. The billing server 20 creates registration data comprising a list of character names corresponding to the character for which each competitor 22 has paid the entry fee and makes the list available to the game master 12. The billing server 20 may be administered by the game master 12 or another representative of the company, but is preferably operated by a third party. The third party may be Netbilling™, Inc. or any other similar corporation.

The servers 16,18,20 and computers 14,24 are preferably of the type commonly available from Dell, Gateway, or Compaq. Each server 16,18,20 and each computer 14,24 preferably has a high-bandwidth connection to the network 26. In order to promote diversity of competitors 22, the network 26 is preferably an open network, such as the Internet. However, the network 26 may be a Local Area Network (LAN) or a Wide Area Network (WAN).

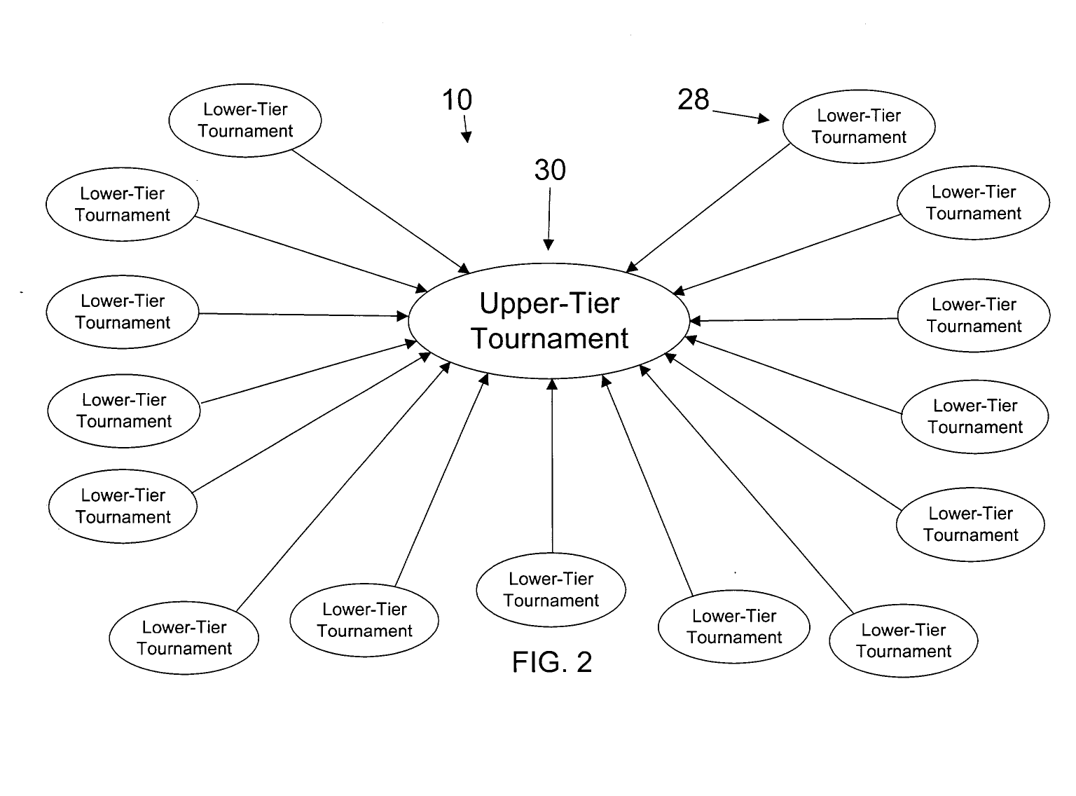

Referring also to FIG. 2., the tournament method 10 of the present invention is preferably conducted in at least two phases, each phase comprising several small steps. A first phase broadly comprises conducting a plurality of lower-tier tournaments 28, while a second phase broadly comprises conducting an upper-tier tournament 30. Each competitor 22 pays the entry fee in order to compete in one of the lower-tier tournaments 28. Competitors 22 who win one of the lower-tier tournaments 28 are referred to as lower-tier winners and allowed to compete in the upper-tier tournament 30. Competitors 22 who win the upper-tier tournament 30 are referred to as upper-tier winners and are entitled to a share of a prize. Each tournament 28,30 is conducted by the game master 12 in the gaming environment on the game server 16. Each tournament 28,30 may be any one of three types and may comprise one or more matches. The three types are a one-on-one tournament, a free-for-all tournament, or a quest tournament. The one-on-one tournament is preferably conducted as a common double-elimination tournament with both a winner's bracket and a loser's bracket. The one-on-one tournament is preferably held in an arena in the gaming environment and is initiated by the game master 12 summoning two characters to the arena. The game master 12 preferably observes the two characters battle each other in a best-of-three competition. The first character to defeat the other character two times advances to the winner's bracket, while the other character moves to the loser's bracket. The winner of a final match is declared the lower-tier winner.

The free-for-all tournament is also preferably conducted by the game master 12 in the arena and comprises all characters assigned to the free-for-all tournament competing against each other simultaneously. The last character standing is declared the lower-tier winner.

The quest tournament is preferably conducted by the game master 12 and may involve the entire gaming environment. The quest tournament comprises a goal, such as, a goal to defeat a special monster and return with an item guarded by the special monster. All characters may compete simultaneously or individually. The character who defeats the special monster and returns with the item first quickest is declared the lower-tier winner.

Before registering for one of the lower-tier tournaments 28, each competitor 22 is preferably expected to create their character and build that character up to level 19. Competitors 22 are allowed to compete with characters at levels below 19. However, they do so at a disadvantage, since it is expected that the majority of competitors 22 will compete with characters of level 19. Competitors 22 are generally not allowed to compete with characters at levels greater than 19. However, special tournaments may be held for levels below and/or above level 19.

When the competitors 22 register with and pay the entry fee to the billing server 20, they are allowed to choose which one of the plurality of lower-tier tournaments 28 in which they would like compete. Each lower-tier tournament 28 starts on a different date and/or at a different time.

The game master 12 receives the registration data from the billing server 16 and creates a tournament plan according to the tournament type and a threshold number. The tournament plan specifies how the lower-tier tournaments 28 will be conducted and which competitors 22 are assigned to each lower tier tournament 28. Each competitor 22 is preferably assigned to the lower-tier tournament 22 they chose when they registered with the billing server 20. However, each competitor 22 may be assigned to another lower-tier tournament 28 for any number of reasons, such as, too many or too few competitors 22 have chosen a particular lower-tier tournament 28.

The game master 12 conducts each tournament 28,30 on the game server 16 according to the tournament plan. Lower-tier winners advance to compete in the upper-tier tournament 30. There may be more than one lower-tier winner in each lower-tier tournament 28, as specified in the tournament rules posted on the web server 16. Similarly, there may be more than one upper-tier winner.

Tournaments 28,30 are preferably conducted over a 30 day period. The first four weeks of the 30 day period are preferably reserved for lower-tier tournaments 28. The last day of the 30 day period is preferably reserved for the upper-tier tournament 30. This allows a maximum number of competitors 22 to compete at convenient times.

The threshold number is a maximum number of competitors 22 that may be assigned to any one lower-tier tournament 28. The threshold number ensures that lower-tier tournaments 28 are kept small. The threshold number also ensures that the entry fee is kept small in comparison with the prize. In this manner, the threshold number ensures that the prize is worth more than the sum of the entry fees for any one tournament 28,30.

For example, a specific set of tournament rules may specify that, the threshold number is 10, the entry fee is $10, the prize will be 90% of the sum of all entry fees, there will be two winners of each tournament, and the upper-tier winners will split the prize evenly. If 43 competitors 22 register, the tournament plan would consist of at least five lower-tier tournaments 28. Each competitor 22 would pay $10in order to register for one of the five lower-tier tournaments 28 and complete for half of the prize. The game master 12 may create more than, but not fewer than, five lower-tier tournaments 28. One reason the game master 12 would create more than five lower-tier tournaments 28 might be to allow more of the competitors 22 to compete at the date and time they chose when they registered with the billing server 16.

Continuing the example, the prize would be $387 which is 90% of 43multiplied by $10. Each upper-tier winner would receive $193.50 which is half of $387. The competitors 22 compete in small groups of approximately 10, making each tournament 28,30 quick and enjoyable. In this case, each competitor 22 pays $10 to have two chances to win $193.50 which is nearly double the entry fee multiplied by the number of competitors 22 in each tournament 28,30.

As an additional example, another set of tournament rules may specify that the threshold number is 50, the entry fee is $10, the prize will be 90% of the sum of all entry fees, there will be two winners of each tournament, and the upper-tier winners will split the prize evenly. If 10,000 competitors 22 register, the tournament plan would consist of at least 200 tournaments. In this case, the prize would be $90,000 which is 90% of 10,000 multiplied by $10. Each upper-tier winner would receive $45,000 which is half of $90,000. In this case, each competitor 22 pays $10 to have two chances to win $45,000.

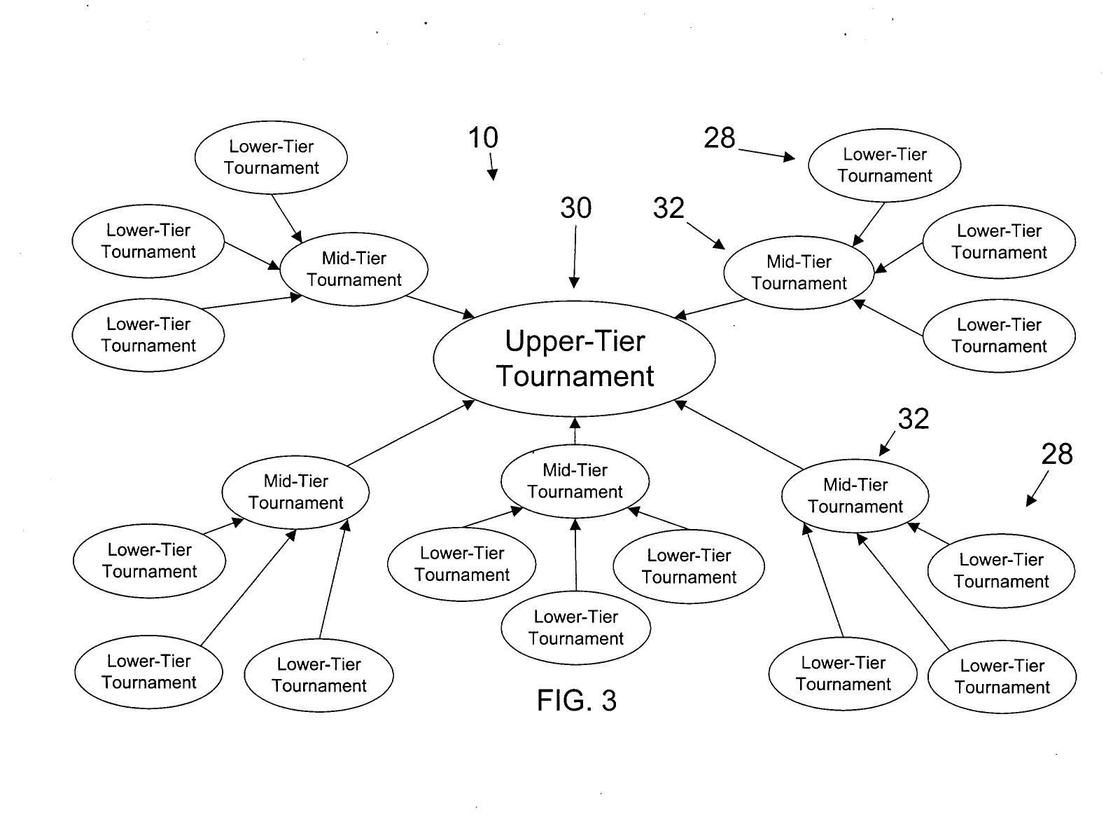

As shown in FIG. 3 this example may require a plurality of mid-tier tournaments 32. The mid-tier tournaments 32 may be inserted between the lower-tier tournaments 28 and the upper-tier tournament 30. The lower-tier winners would compete in the mid-tier tournament 32 in order to decide which lower-tier winners are allowed to advance to the upper-tier tournament 30. In this manner, the upper-tier tournament 30 is also kept small by only allowing some of the lower-tier winners to compete in the upper-tier tournament 30.

As a final example, another set of tournament rules may specify that the threshold number is 1,000, the entry fee is $10, the prize will be 95% of the sum of all entry fees, there will be three winners in each lower-tier tournament. This set of tournament rules may also specify that a first place upper-tier winner will receive 10% of the sum of all entry fees, a second place upper-tier winner will receive 6% of the sum of all entry fees, and a third place upper-tier winner will receive 4% of the sum of all entry fees, while the remaining 75% of the sum of all entry fees that constitutes the prize will be split evenly among the next 1,000 highest ranked competitors 22. If 1,000,000 competitors 22 register, the tournament plan would consist of at least 1,000 tournaments.

In this case, the prize would be $9,500,000 which is 95% of $10,000,000. The first place upper-tier winner would receive $1,000,000, which is 10% of the sum of all entry fees. The second place upper-tier winner would receive $600,000, which is 6% of the sum of all entry fees. The third place upper-tier winner would receive $400,000, which is 4% of the sum of all entry fees. Additionally, the next 1,000 highest ranked competitors 22 would each receive $7,500 which is an equal share of the remaining 75% of the sum of all entry fees that constitutes the prize. In this case, each competitor 22 pays $10 to have three chances to win at least $400,000 which is forty times the entry fee multiplied by the number of competitors 22 in each tournament 28,30. Additionally, each competitor 22 has over 1,000 chances to win at least $7,500, which is 750 times the entry fee each competitor 22 paid.

Furthermore, hosting a 1,000,000 competitor tournament would be impractical and require large investments of both time and infrastructure, without the tournament method 10 of the present invention. The tournament method 10 of the present invention keeps each tournament 28,30 small in order to simplify hosting and enhance competitor 22 enjoyment of the tournaments 28,30.

It is anticipated that features may be added to the tournament method 10, such as, a handicapping feature to allow characters of significantly different levels to compete. For instance, a level 25 character may be handicapped to complete against a level 15 character such that the level 25 character does not have a significant advantage. Alternatively, a bonus feature may allow the level 15 character to compete against the level 25 character such that the level 15 character competes at the same level as the level 25 character.

While the present invention has been described above, it is understood that substitutes can be made. For instance, the tournament method 10 may be used with different gaming environments, such as, computer networked card games and board games. Additionally, techniques other than the threshold number may be employed to ensure that the lower-tier tournaments 28 are kept small and the entry fee is kept small in comparison with the prize. For example, a minimum number of lower-tier tournaments may be used. These and other minor modifications are within the scope of the present invention.

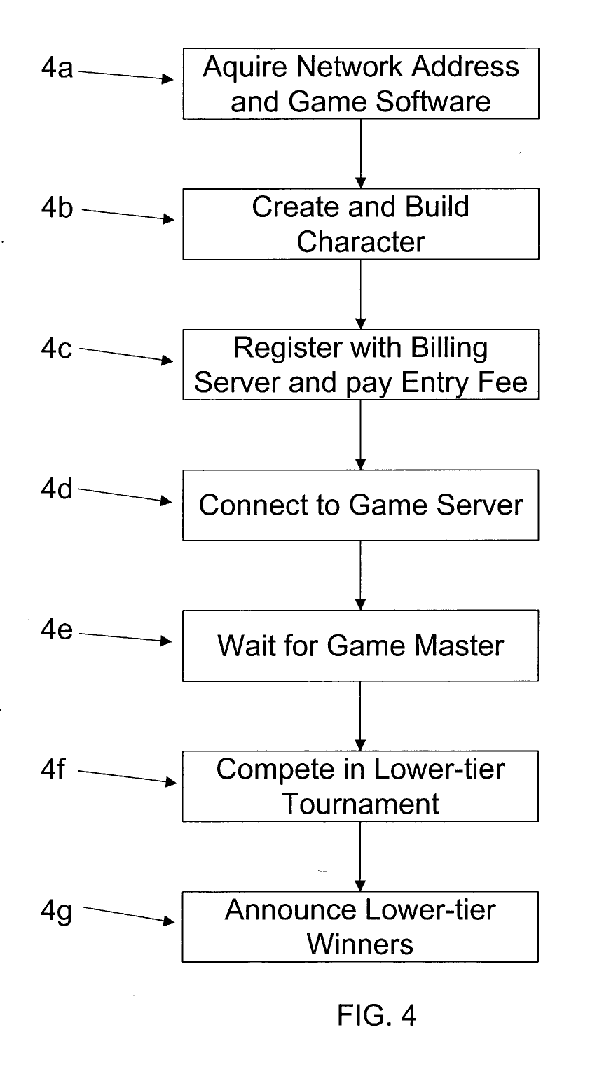

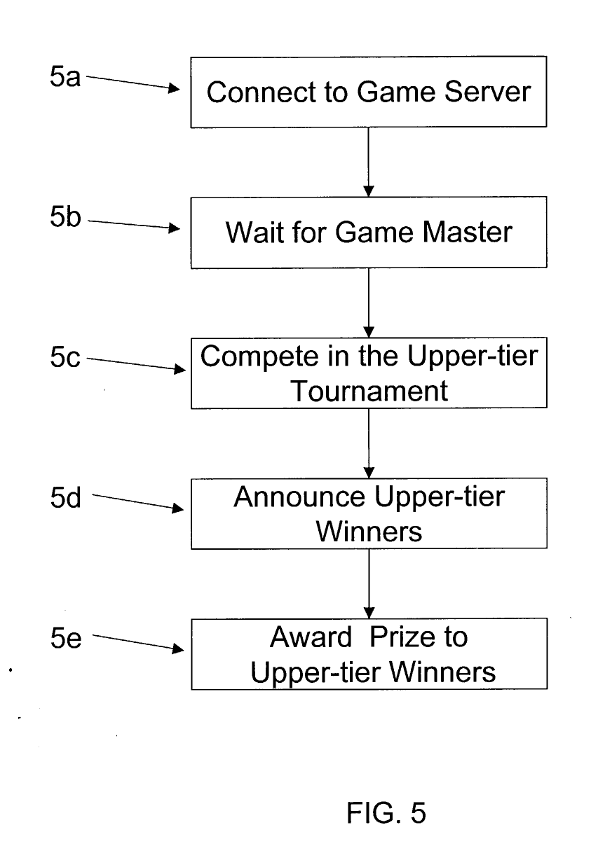

The flow charts of FIG. 4 and FIG. 5 show the functionality and operation of a preferred implementation of the present invention in more detail. In this regard, some of the blocks of the flow chart may represent a module segment or portion of code of a program of the present invention which comprises one or more executable instructions for implementing the specified logical function or functions. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

In use, as shown in FIG. 4, each competitor 22 acquires the game software package and the network address of the game server 16, as depicted in step 4a. Each competitor 22 creates and builds their character to level 19, as depicted in step 4b. The competitors 22 also register with the billing server 20 and pay the entry fee, as depicted in step 4c. Then, shortly before the assigned lower-tier tournament 28 is scheduled to start, each competitor 22 configures the game software with the network address of the game server 16 and connects to the game server 16, as depicted in step 4d. Then, the competitors 22 wait for the game master 12 to start the assigned lower-tier tournament 28, as depicted in step 4e. When summoned to the arena, the competitors 22 use their character to compete in the lower-tier tournament 28, as depicted in step 4f.

Once each lower-tier tournament 28 is complete, a lower-tier winner or winners are announced, as depicted in step 4g. All lower-tier tournaments 28 are preferably conducted in this manner. Those lower-tier winners will be allowed to compete in the upper-tier tournament 30 for the prize.

Also referring to FIG. 5, shortly before the upper-tier tournament is scheduled to start, all lower-tier winners connect to the game server, as depicted in step 5a. The lower-tier winners wait for the game master to start the upper-tier tournament, as depicted in step 5b. When summoned to the arena, the lower-tier winners use their character to compete in the upper-tier tournament 30, as depicted in step 5c.

Once the upper-tier tournament 30 is complete, the upper-tier winner or winners are announced, as depicted in step 5d. Those upper-tier winners are awarded the prize, as depicted in step 5e. For instance, if there are two upper-tier winners, those upper-tier winners split the prize according to the prize sharing rules posted on the web server 18.

Having thus described a preferred embodiment of the invention, what is claimed as new and desired to be protected by Letters Patent includes the following:

1. A method of hosting a multi-tier tournament, the method comprising the steps of:
a) receiving registration data relating to a plurality of competitors;
b) allowing each competitor that meets an entry criteria to compete in one of a plurality of lower-tier tournaments;
c) conducting each lower-tier tournament;
d) announcing at least one lower-tier winner for each lower-tier tournament;
e) allowing each lower-tier winner to compete in an upper-tier tournament;
f) conducting the upper-tier tournament;
g) announcing at least one upper-tier winner; and
h) distributing a prize among the upper-tier winners.

2. The method as set forth in claim 1, further comprising the step of specifying a game server network address for the game server.

3. The method as set forth in claim 2, further comprising the step of posting the game server network address on a web server.

4. The method as set forth in claim 1, further comprising the step of posting a start date and a start time for each of the plurality of lower-tier tournaments and the upper-tier tournament on a web server wherein each tournament has a different start date and start time combination.

5. The method as set forth in claim 1, further comprising the step of specifying a maximum experience level for competition in the multi-tier tournament.

6. The method as set forth in claim 5, further comprising the step of posting the maximum experience level on a web server.

7. The method as set forth in claim 1, wherein the registration data includes a plurality of character names and an indication of which competitor has registered each character name.

8. The method as set forth in claim 1, wherein the registration data is received from a billing server.

9. The method as set forth in claim 1, further comprising the step of creating a tournament plan according to a threshold number, wherein the threshold number specifies a maximum number of competitors that may be assigned to each lower-tier tournament.

10. The method as set forth in claim 9, wherein the prize is of a value greater than the threshold number multiplied by an entry fee.

11. The method as set forth in claim 1, wherein the entry criteria includes a requirement to pay an entry fee.

12. The method as set forth in claim 1, wherein the entry criteria includes a requirement to not exceed a maximum experience level.

13. The method as set forth in claim 1, further comprising the step of collecting an entry fee from each competitor for competing in one of the lower-tier tournaments and combining those entry fees into the prize that is awarded to winners of the upper-tier tournament.

14. A method of hosting a multi-tier tournament, the method comprising the steps of:
a) specifying a game server network address for the game server;
b) specifying a maximum experience level for competition in the multi-tier tournament;
c) posting the game server network address and the maximum experience level on a web server;
d) receiving registration data relating to a plurality of competitors from a billing server;
e) allowing each competitor that meets an entry criteria to compete in one of a plurality of lower-tier tournaments;
f) conducting each lower-tier tournament through a game server;
g) announcing at least one lower-tier winner for each lower-tier tournament;
h) allowing each lower-tier winner to compete in an upper-tier tournament;
i) conducting the upper-tier tournament through the game server;
j) announcing at least one upper-tier winner; and
k) distributing a prize among the upper-tier winners.

15. The method as set forth in claim 14, further comprising the step of posting a start date and a start time for each of a plurality of lower-tier tournaments and one upper-tier tournament on the web server wherein each tournament has a different start date and start time combination

16. The method as set forth in claim 14, wherein the registration data includes a plurality of character names and an indication of which competitor has registered each character name.

17. The method as set forth in claim 14, further comprising the step of creating a tournament plan according to a threshold number, wherein the threshold number specifies a maximum number of competitors that may be assigned to each lower-tier tournament.

18. The method as set forth in claim 17, wherein the prize is of a value greater than the threshold number multiplied by an entry fee.

19. The method as set forth in claim 1, wherein the entry criteria includes a requirement to pay an entry fee and not exceed a maximum experience level.

20. A method of hosting a multi-tier tournament, the method comprising the steps of:
a) specifying a game server network address for a game server;
b) specifying a start date and a start time for each of a plurality of lower-tier tournaments and one upper-tier tournament, wherein each tournament has a different start date and start time combination;
c) specifying a maximum experience level for competition in the multi-tier tournament;
d) posting the game server network address, the start date and start time combinations, and the maximum experience level on a web server;
e) receiving registration data relating to a plurality of competitors from a billing server, wherein the registration data includes a plurality of character names and an indication of which competitor has registered each character name;
f) confirming that each character name corresponds to one of a plurality of characters, wherein the character does not exceed the maximum experience level;
g) creating a tournament plan according to a threshold number, wherein the threshold number specifies a maximum number of competitors that may be assigned to each lower-tier tournament;
h) allowing each competitor that has paid an entry fee and properly registered their character to compete in one of the plurality of lower-tier tournaments using their character;
i) conducting each lower-tier tournament through the game server;
j) announcing at least one lower-tier winner for each lower-tier tournament;
k) allowing each lower-tier winner to compete in the upper-tier tournament;
I) conducting the upper-tier tournament through the game server;
m) announcing at least one upper-tier winner; and
n) distributing a prize among the upper-tier winners, wherein the prize is of a value greater than the threshold number multiplied by the entry fee.
